(19) United States
(12) Patent Application Publication
(10) Pub. No.: US 2019/0389555 A1
(43) Pub. Date: Dec. 26, 2019

(54) AIRCRAFT MODULE OF A DESIGN THAT MAKES IT EASIER TO ASSEMBLE IN AN INTERIOR SPACE DEFINED BY THE FUSELAGE OF THE AIRCRAFT

(71) Applicant: Airbus Operations (S.A.S.), Toulouse (FR)

(72) Inventor: Bernard Guering, Montrabe (FR)

(21) Appl. No.: 16/448,902

(22) Filed: Jun. 21, 2019

(30) Foreign Application Priority Data
Jun. 25, 2018 (FR) 1855676

(51) Int. Cl. B64C 1/06; B64F 5/10; B64D 11/04

(52) U.S. Cl. CPC B64C 1/069; B64F 5/10; B64C 1/18; B64C 1/061; B64D 11/04

(57) ABSTRACT

In order to make it easier to assemble an aircraft module in an interior space defined by a fuselage of this aircraft, this module includes at least one transverse member extending in a lateral direction of the module and intended to be fixed to a frame of the fuselage, and it also includes, mounted on at least one of the two opposite ends of the transverse member, a joining device for joining to the fuselage frame, the joining device being configured to be movable from a standby position into a deployed joining position in which this device projects from the transverse member in the lateral direction.

### CROSS-REFERENCE TO RELATED APPLICATION

This application claims priority to French patent application number 18 55676 filed on Jun. 25, 2018, the entire disclosure of which is incorporated by reference herein.

### TECHNICAL FIELD

The disclosure herein relates to the field of the assembly of the various components of an aircraft.

It relates more specifically to assembly methods involving creating modules incorporating several components and functionalities beforehand, before mounting these modules on the structure of the aircraft.

The disclosure herein preferably applies to commercial airplanes.

### BACKGROUND

With a view to reducing the time taken to assemble the various components of an aircraft, these components may be grouped together beforehand into a module which is intended to be mounted later on the structure of the aircraft.

However, the higher the number of components that the module incorporates, the more complicated it proves to be to fit.

This may first of all be explained in terms of the difficulty there is in accessing the points at which the module is fixed to the structure of the aircraft, when these points are situated in highly populated zones which for example incorporate a plurality of equipment items.

However, this difficulty can also be explained in terms of the large size of the module, which makes it complicated to move around within the structure while it is being transferred towards its definitive location. Specifically, when the module is very wide, moving it around within the structure carries the risks of interference with the fuselage frames. This movement has therefore to be performed at low speed in order to avoid collisions with the fuselage frames, and this has a negative impact on the production rates for aircraft incorporating such modules.

There is therefore a need to optimize the design of these modules, to make them easier to assemble.

### SUMMARY

In order to at least partially address this requirement, a first subject of the disclosure herein is a module for an aircraft intended to be assembled in an interior space defined by a fuselage of this aircraft, the module comprising at least one transverse member extending in a lateral direction of the module and intended to be fixed to a frame of the fuselage. The module also comprises, mounted on at least one of the two opposite ends of the transverse member, a joining device for joining to the fuselage frame, the joining device being configured in such a way as to be able to be moved from a standby position into a deployed joining position in which this device projects from the transverse member in the lateral direction.

The disclosure herein makes the module easier to assemble because it plans for at least one end of a transverse member of the module to be fixed to a fuselage frame. This fuselage frames zone is usually readily accessible to operators, leading to shorter intervention times.

Module assembly is also made easier by the possibility of making the module adopt a smaller lateral size, while it is being moved towards its definitive location within the interior space defined by the fuselage. In effect, during this movement, the joining device(s) of the module can adopt their standby position, in order considerably to reduce the risks of interference with the fuselage frames. The speed at which the module can be moved around can therefore be increased, thus improving production rates.

The disclosure herein preferably envisions at least one of the following optional features, considered in isolation or in combination.

When the joining device is in the standby position it is connected to its associated end of the transverse member by an articulated connection, allowing this device to move towards its deployed joining position, in which this device is preferably situated in the continuation of the transverse member in order therewith to form an assembly that is continuous in the lateral direction. This preferential feature may also be applied whatever the nature of the movement of the joining device.

When the joining device is in the deployed joining position it is fixed to its associated end of the transverse member by a plurality of tightening members, preferably bolts, oriented substantially orthogonally to the lateral direction of the module. The tightening members then pass through oblong passage holes made through the end of the transverse member.

The joining device has a friction surface collaborating with a complementary friction surface provided on the web of the transverse member, when the joining device is in its deployed joining position.

The joining device comprises a joining end for joining to the fuselage frame, this joining end comprising a contact surface through which there pass passage holes intended to accept a plurality of traction members, these likewise being intended to collaborate with the fuselage frame when the joining device is in its deployed joining position.

In a plane of section parallel to the lateral direction and to a vertical direction of the module and which passes through the transverse member, the contact surface adopts the shape of a straight line segment inclined with respect to the vertical direction.

The module comprises at least one of the following components, and preferably a plurality of these components or even all of these components:
a floor comprising the at least one transverse member;
at least one system;
at least one cockpit lining;
at least one door system;
at least one bulk head;
at least one onboard galley;
at least one toilet cubicle.

The transverse member equipped with the joining device is arranged in a rear part of the module.

The transverse member is equipped with a joining device at each of its opposite ends, and/or several transverse members of the module are each equipped with at least one joining device.

Another subject of the disclosure herein is an aircraft part comprising a fuselage forming a structural envelope and comprising fuselage frames, the aircraft part also comprising at least one such module assembled in the interior space defined by the fuselage, with each joining device being in the deployed joining position and fixed to at least one of the fuselage frames.

For preference this aircraft part is an aircraft nose cone.

Another subject of the disclosure herein is an aircraft comprising at least one such part.

A final subject of the disclosure herein is a method for assembling such an aircraft part, comprising the following steps:
placing the module facing and some distance away from its definitive location in the interior space defined by the fuselage, with each joining device in the standby position;
moving the module to bring it into its definitive location;
moving each joining device into its deployed joining position; and
fixing each joining device to the fuselage frame(s).

For preference, the step of moving the module is performed by setting it in a translational movement in a longitudinal direction of the module and of the fuselage until it reaches its definitive location.

Further advantages and features of the disclosure herein will become apparent from the nonlimiting detailed description given hereinbelow.

### BRIEF DESCRIPTION OF THE DRAWINGS

This description will be given with reference to the attached drawings among which:

FIG. 1 depicts a side elevation of an aircraft according to the disclosure herein;

FIG. 2 depicts a side view of the nose cone of the aircraft shown in the previous figure;

FIG. 3 depicts a perspective view of the aircraft nose cone shown in FIG. 2;

FIG. 4 is a perspective view of the module with which the nose cone shown in FIGS. 2 and 3 is equipped;

FIG. 4′ is a perspective view of the fuselage with which the nose cone shown in FIGS. 2 and 3 is equipped and which is intended to accept the module depicted in FIG. 4;

FIG. 5 depicts a perspective view of a transverse member of the nose cone module depicted in FIG. 4, the transverse member being equipped with a joining device for joining to the fuselage frame, in a standby position;

FIG. 6 is an exploded perspective view of the transverse member/joining device assembly shown in the preceding figure; and

FIGS. 7a through 7f″ are views illustrating various successive steps in a method for assembling the nose cone shown in the preceding figures.

### DETAILED DESCRIPTION

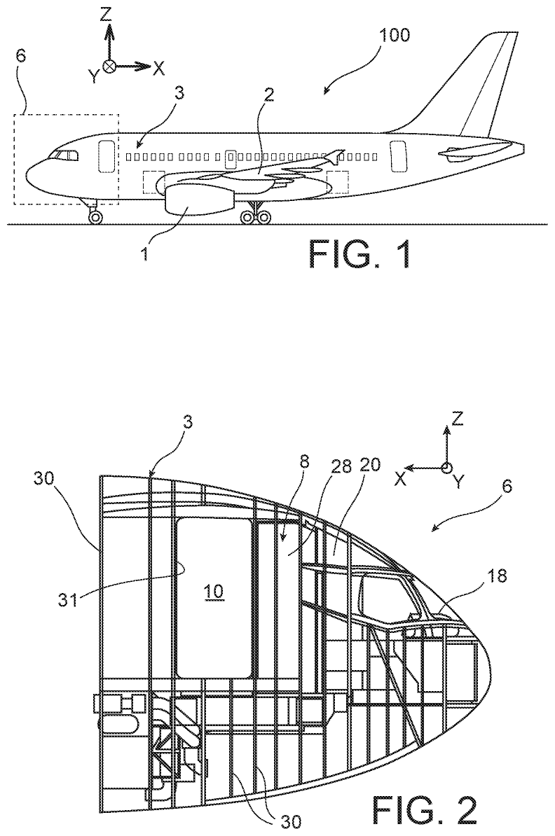

Reference is made to FIG. 1, which depicts an aircraft 100 of the commercial airplane type, comprising two wings 2 (just one visible in FIG. 1) attached to a fuselage 3 and each bearing a turbomachine 1 of the bypass type, such as a turbojet engine.

On this aircraft 100 there is a nose cone 6 which is specific to the disclosure herein and a preferred embodiment of which will now be described with reference to the subsequent figures. In this regard, it is noted that the principle behind the disclosure herein, as will be set out hereinbelow, is applicable to other parts of the aircraft and, more particularly, to other aircraft sections comprising a fuselage and a module assembled inside the space defined by this fuselage.

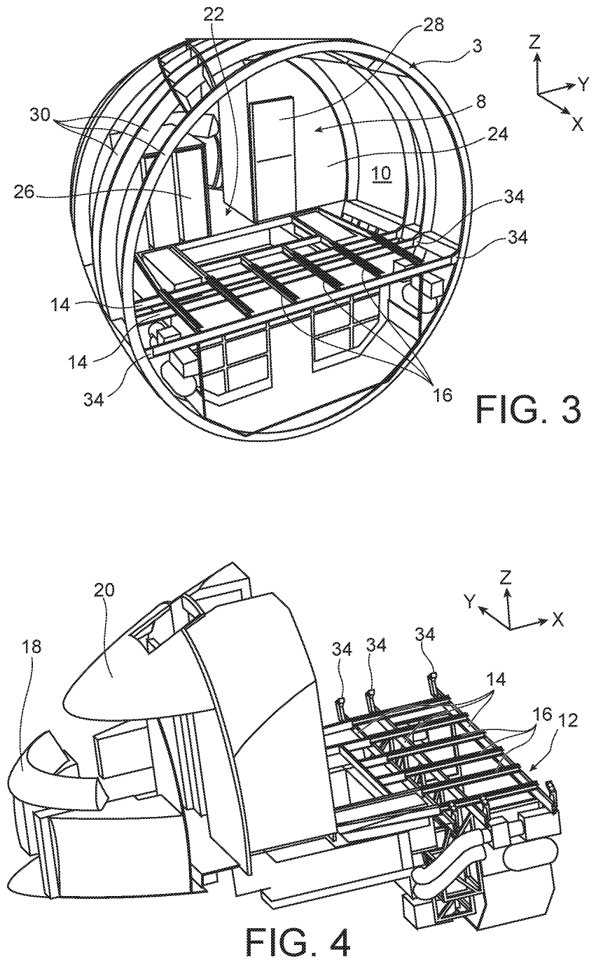

With reference first of all to FIGS. 2 and 3, these depict part of the nose cone 6, as obtained by simply assembling a nose cone module 8 in an interior space 10 defined by the fuselage 3 of this nose cone. Because of the very self-contained nature of the module, also referred to as an “integral module”, this simple assembly leads to a near-finished nose cone 6. In other words, assembling the module 8 on the fuselage 3 leads to a nose cone which requires very few subsequent operations in order to result in a finalized version ready to be assembled with the other sections of the aircraft.

Throughout the description which will follow, by convention, the direction X corresponds to the longitudinal direction of the aircraft, this direction also corresponding to the longitudinal direction of the nose cone 6, and to that of the module 8 and of the fuselage 3 that form this cone. Furthermore, the direction Y corresponds to the lateral or transverse direction of the aircraft, this direction also corresponding to the lateral direction of the nose cone 6, and to that of the module 8 and of the fuselage 3 that make up this cone. Finally, the direction Z corresponds to the vertical or height direction, these three directions X, Y, Z being mutually orthogonal.

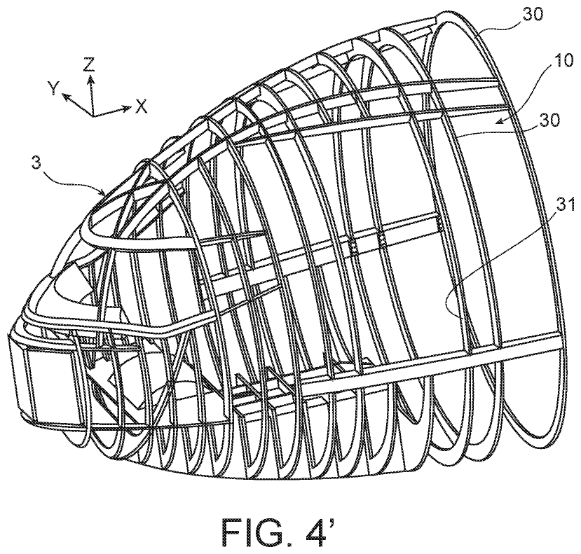

The module 8 is particularly self-contained, incorporating numerous components of the nose cone 6. This module 8, visible in FIGS. 2 to 4, comprises one or more components including:
a floor 12 comprising a plurality of transverse members 14 parallel to the direction Y. The transverse members 14, of which there are for example three, are situated in a rear part of the module 8 and connected to one another by longitudinal members 16 parallel to the direction X. The floor 12 may also comprise one or more skins attached to the longitudinal members 16/transverse members 14;
at least one system 18, for example of the navigation system or equipment type;
at least one cockpit lining 20;
at least one door system 22;
at least one bulk head 24;
at least one onboard galley 26;
at least one toilet cubicle 28.

For preference, it is all of these components that are incorporated into the module 8, possibly in combination with other components still. The module 8 is therefore multifunctional, incorporating a multitude of elements which are assembled with one another before this module 8 is assembled in the interior space 10 defined by the fuselage 3 of the nose cone visible in FIGS. 2, 3 and 4′.

This fuselage 3, which corresponds to a front section of the aircraft fuselage, has a conventional ogive-shaped design, of which the dimensions in the directions Y and Z narrow nearer the front in the direction X. The fuselage 3 defines a structural envelope, the void of which corresponds to the interior space 10 that accepts the module 8. In order to produce this fuselage, frames 30 spaced apart in the direction X and inscribed in planes YZ are provided. The frames 30 extend all around the envelope, with a shape similar to the local shape of the fuselage 3. The latter also has skins (not depicted) attached to the frames 30, notably to form the aerodynamic surface of the fuselage. This fuselage 3 incorporates an opening 31 to accept a forward door providing access to the interior of the aircraft.

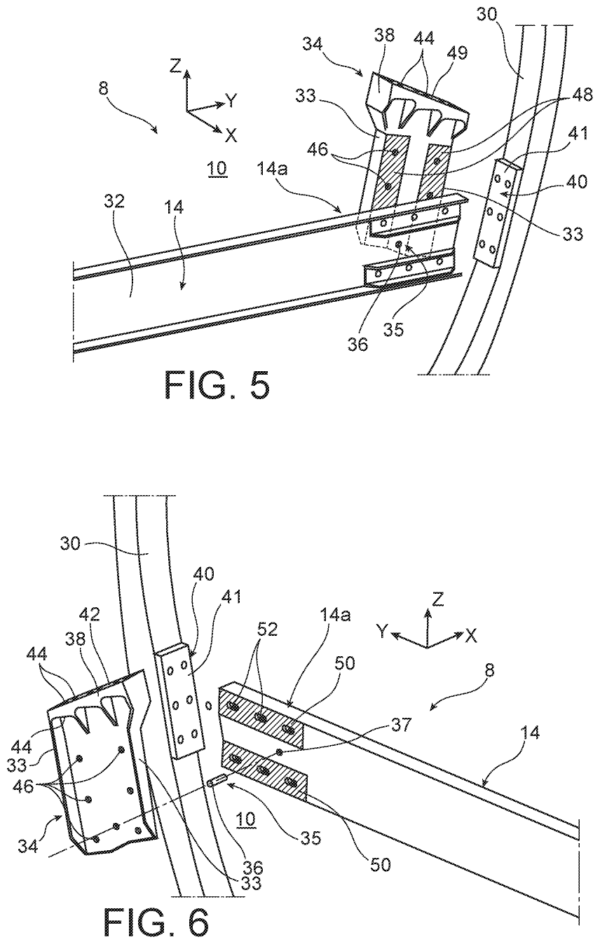

It is to these fuselage frames 30 that the module 8 is fixed, via one or more of its transverse members 14, part of one of which has been depicted in enlargement in FIGS. 5 and 6. It should nevertheless be appreciated that the three transverse members 14, each of which extends locally along a length slightly shorter than that of the interior space 10 delimited by the frames 30, preferably all have the same or similar design.

The transverse member 14 comprises a web 32 preferably extending in a plane YZ. At least at one of the two opposite ends 14a of the transverse member, and preferably at each of these ends, the module 8 comprises a joining device 34 specific to the disclosure herein. This device 34 is preferably mounted in an articulated manner on its associated end 14a of the transverse member 14, via an articulated connection 35 that allows it to rotate. This connection comprises an articulation member 36 parallel to the direction X, passing through the device 34 and its associated end 14a, preferably at an oblong hole 37 of this end. Nevertheless, any other connection could be envisioned between the joining device 34 and the end 14a of the transverse member. This connection would then need to be designed to allow the device 34 to be moved from a standby position in which it represents only a small bulk in the direction Y towards the outside from the end of the transverse member 14a, into a deployed joining position in which this device 34 projects more from the transverse member 14, in the direction Y, towards the outside.

FIGS. 5 and 6 depict the joining device 34 in its standby position, as adopted before the module 8 is mounted on the fuselage 3. In this position, the articulation member 36 connects the device 34 to its associated end 14a, with the device 34 projecting upwards. For preference, no part of the device 34 extends beyond the end 14a of the transverse member, in the direction Y. This specific feature advantageously gives the module 8 a reduced lateral bulk while it is being assembled. The joining device 34 may be kept in this standby position by construction, or by axially clamping the articulated connection 35 when its design so permits, or alternatively still, using a non-aggressive temporary clamp (not depicted) that keeps the two elements 14a, 34 bearing axially against one another.

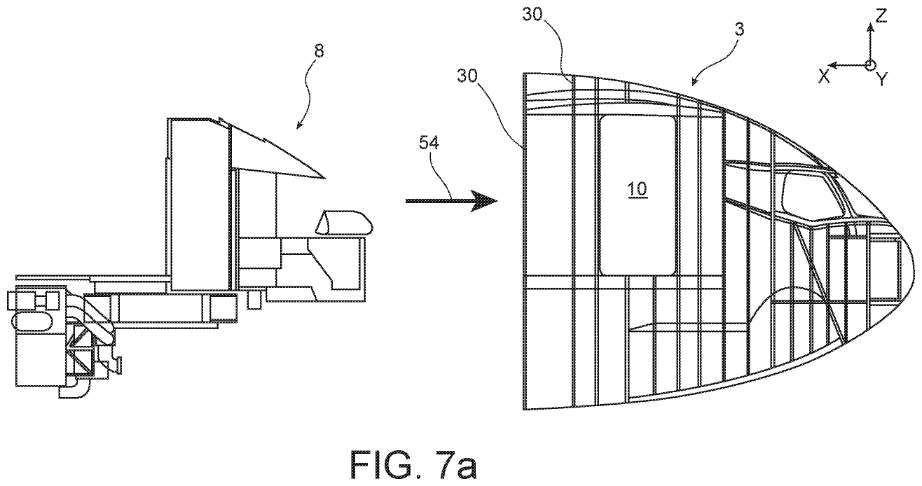

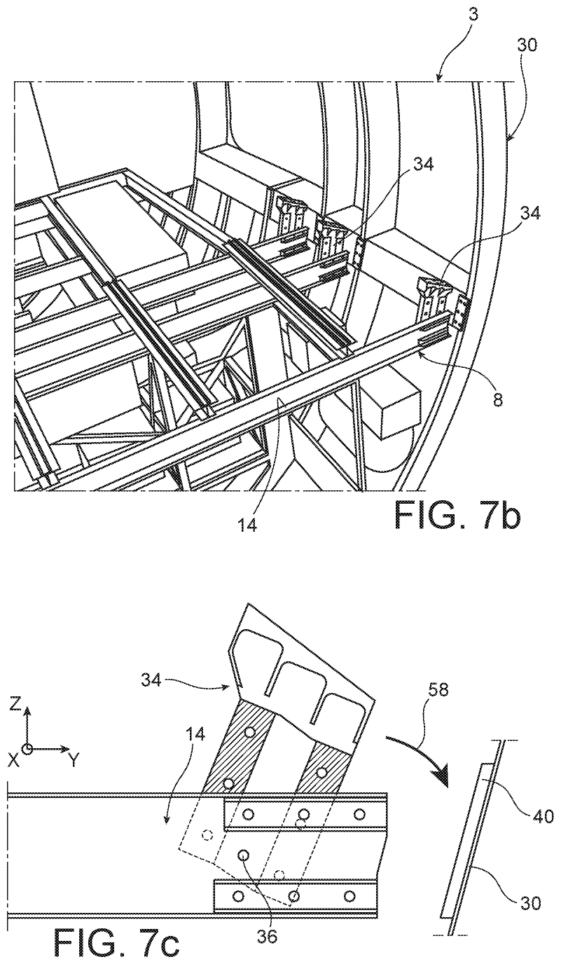

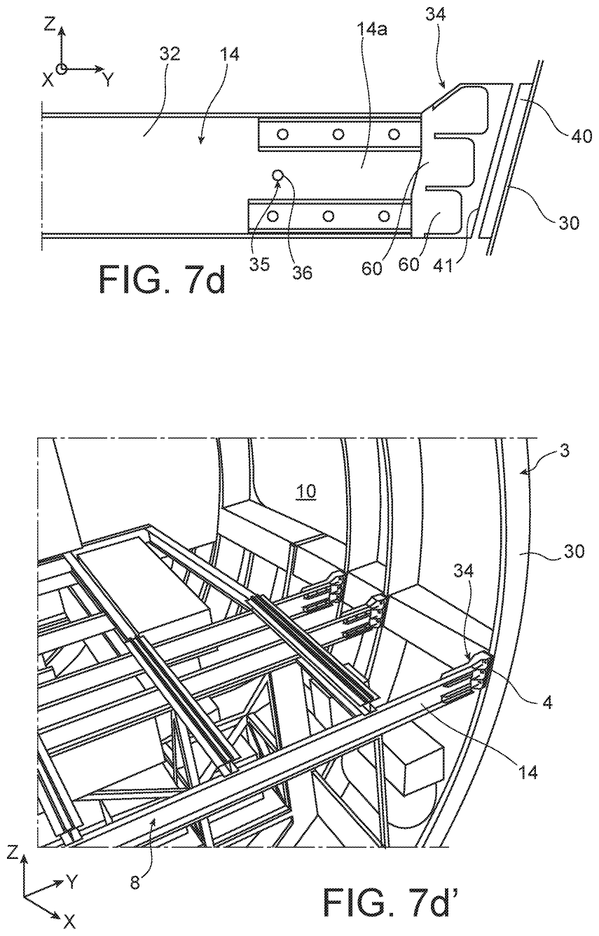

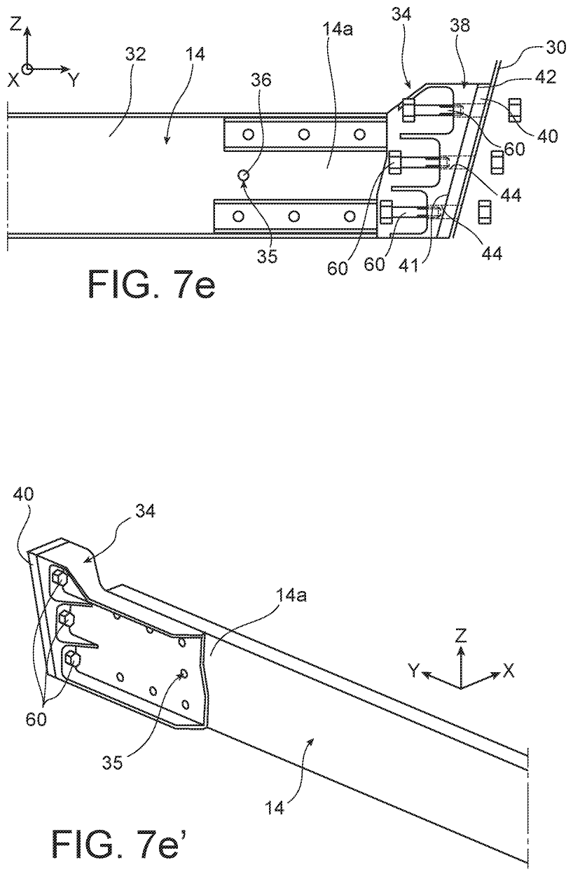

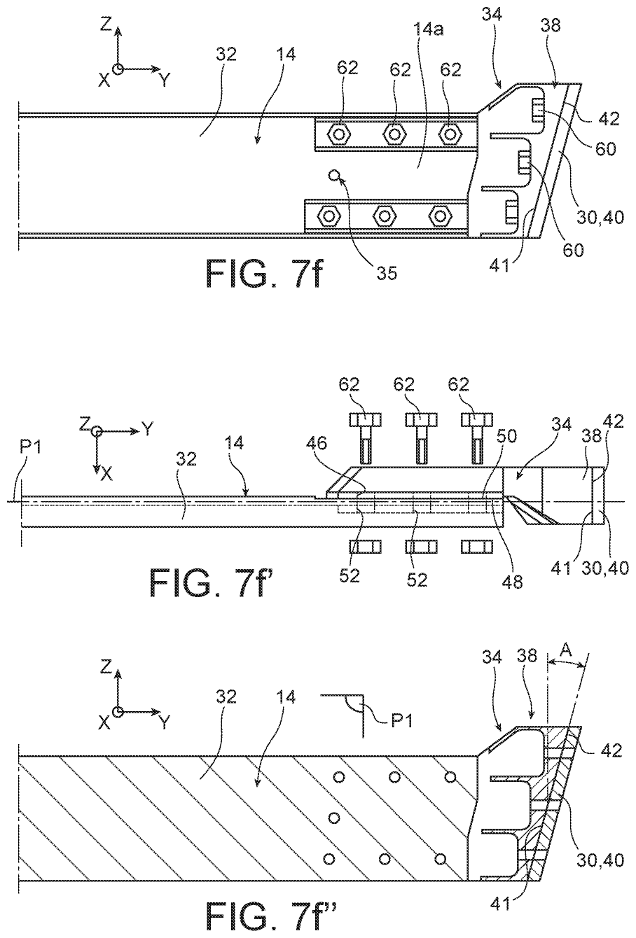

By contrast, in the deployed joining position as shown in FIGS. 7f to 7f″, the device 34 laterally extends the end of the transverse member 14a towards the outside, as far as the fuselage frame 30 to which it is fixed as will be described hereinafter. The device 34 is then situated in the continuation of the transverse member in order therewith to form an assembly that is continuous in the direction Y, namely a unit assembly extending in this same direction.

Overall, the device 34 in its distal part comprises a joining end 38 which comes into contact with an attachment fitting 40 attached to or incorporated into the frame 30. The contact surface 42 of this end 38 bears against a complementary surface 41 of the attachment fitting 40. For this reason, in order to obtain satisfactory collaboration between these two surfaces, the contact surface 42 is inclined in such a way as to adapt to the local inclination of the complementary surface 41 of the attachment fitting 40. More specifically, in a plane of section P1 such as that of FIG. 7f″, which plane is parallel to the directions Y and Z and passes through the web 32 of the transverse member 14, the contact surface 40 adopts the form of a straight line segment inclined by a nonzero angle A with respect to the direction Z. Given that the module 8 is preferably attached to a lower part of the frame 30, the inclination of the straight line segment is such that it diverges laterally outwards in an upwards direction, like the complementary surface 41. The angle A is for example planned to be between 5 and 30°, depending on the local inclination of the frame 30 concerned.

Returning to FIGS. 5 and 6, these show the design of the joining device 34, which preferably adopts the form of a fitting made as a single piece, that is parallelepipedal overall. Its joining end 38 is an outgrowth through which there pass passage holes 44 intended to accept traction members which will be described later, and which serve to attach the device 34 to the fitting 40. These passage holes, of which there are for example six, are distributed in two rows of three holes 44 and open onto the contact surface 42 of the end 38. The outgrowth formed by the latter extends in the thickness direction and in the height direction of the device 34, implying in particular, in this heightwise direction, two non-parallel edge faces 33 for this device 34.

Similarly, the joining device 34 has passing through it passage holes 46 which are intended to accept clamping members which will be described later, and which serve to attach the device 34 to its associated transverse member end 14a. These passage holes, of which there are for example six, are distributed in two rows of three holes 46, and open onto a friction surface 48 of the end 14a. This friction surface 48 is intended to be in contact with a complementary friction surface 50 provided on the web of the transverse-member end 14a when the device 34 adopts its deployed joining position. These two surfaces 48, 50 are, for example, ribbed, striated, or shaped in some other similar way.

Passage holes 52 open onto the complementary friction surface 50 and pass all the way through the web 32 of the transverse-member end 14a. They adopt an oblong shape, elongated in the direction Y so as to compensate for any play with respect to the attachment fitting 40 when the module 8 is being attached to the frames 30. Each oblong passage hole 52 is axially facing and coupled to one of the passage holes 46, given that these holes 46, 52 are intended to have the clamping members passing through them.

A method for assembling the nose cone 6 according to one preferred embodiment of the disclosure herein will now be described with reference to FIGS. 7a to 7f″.

Referring first of all to FIG. 7a, the module 8 is placed axially facing its definitive location in the interior space 10 defined by the fuselage 3. This placement is preferably performed by placing the module 8 at its definitive height with respect to the fuselage. Each joining device 34 (not visible in FIG. 7a) then adopts its standby position, giving the module 8 intended to be introduced into the space 10 a smaller lateral bulk. The next step effectively corresponds to moving the module 8 in order to bring it into its definitive location, this movement taking the form of a translational movement in the direction X, as indicated schematically by the arrow 54 in FIG. 7a. This translational movement may be effected automatically, using appropriate tooling. For preference, it is performed at a high speed at the start of the movement, and then the final approach phase is performed at a lower speed because of the narrowing of the frames 30 of the ogive-shaped fuselage 3. At the end of this movement, the module 8 occupies the position as shown in FIG. 7b, with its joining devices 34 kept in the standby position.

The next step is to pivot these devices 34 into the deployed joining position by pivoting them about the rotation member 36. This step is indicated schematically by the arrow 58 in FIG. 7c. Once the deployed position is reached, as shown in FIGS. 7d and 7d′, each device 34 laterally prolongs the transverse member 14 to come to face the attachment fitting 40. A small clearance in the direction Y may remain between these elements 34, 40. If it does, the deployed joining position is maintained while axially clamping the articulated connection 35 when its design so permits, or using a non-aggressive temporary clamp (not depicted) that keeps the two elements 14, 34 bearing axially against one another. This clamping notably makes it possible to bring the complementary friction surfaces 48, 50 (shown in FIGS. 5 and 6) into contact.

Next, a step of attaching each joining device 34 to its associated fitting 40 is performed using traction members 60 of the bolt or similar type preferably oriented in the direction Y. These bolts 60, depicted in FIGS. 7e and 7e′ pass through the passage holes 44 of the device 34 and through the fitting 40. As they are tightened, any lateral clearance between the surfaces 42, 41 is taken up by the relative movement of the joining device 34 and of its associated transverse-member end 14a. In that regard, it is noted that the play compensation preferably represents a distance shorter than the length of one pitch between the ribs/striations of the complementary friction surfaces 48, 50 (which are shown in FIGS. 5 and 6), so as to make this compensation easier without damaging these surfaces.

Once this step has been completed, the joining devices 34 are thus attached to the fuselage frames 30 and the contact surface 42 of this device remains in contact with the complementary surface 41 of the attachment fitting 40.

The method ends with consolidation of the attachment of the joining devices 34 to their associated transverse-member ends 14a using clamping members 62 in the form of bolts or similar elements oriented in the direction X. This step is indicated schematically in FIGS. 7f to 7f″.

The bolts 62 pass through the passage holes 46 of the device 34 and through the oblong passage holes 52 of the transverse-member end 14a. Nevertheless, it should be noted that the placement of these bolts 62 may alternatively be performed prior to the attachment of the device 34 to the fitting 40 of the fuselage frame, without departing from the scope of the disclosure herein. In such a case, the lateral play between the two surfaces 42, 41 can be taken up by the oblong shape of the passage holes 52 passing through the web of the transverse member 14. Specifically, that design allows relative lateral movement between the device 34 and the transverse member 14 despite the presence of the bolts 62 premounted in the passage holes 46, 52. This advantageously results in a mounting that is substantially isostatic.

Whatever the case may be, the method ends with the tightening of the bolts 62, so as to press the joining device 34 firmly against the web 32 of the transverse-member end 14a, on their complementing friction surfaces 48, 50 referenced in FIG. 7f′.

Operator intervention is easy in this rear part of the module 8 because accessibility to the transverse-member ends 14a is made easier by a low number of components in this zone. Several operators can even work simultaneously on all the transverse members concerned with attachment to fuselage frames. These operations are moreover simple and quick to perform, given that the bolts 60, 62 can be tightened using power drivers.

The attachment of the structural part of the module 8 to the fuselage 3 can essentially be summarized to the attachment of its joining devices 34 to the frames 30. Other ancillary attachments may nevertheless be envisioned, such as the attachment of the module 8 to each fuselage frame 30, in the region of the roof of the front landing gear compartment.

Of course, various modifications may be made by those skilled in the art to the disclosure herein which has just been described solely by way of nonlimiting examples and the scope of which is defined by the attached claims.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemple embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A module for an aircraft for assembly in an interior space defined by a fuselage of the aircraft, the module comprising at least one transverse member extending in a lateral direction of the module and configured to be fixed to a frame of the fuselage, and wherein it comprises, mounted on at least one of two opposite ends of the transverse member, a joining device for joining to the fuselage frame, the joining device configured to be movable from a standby position into a deployed joining position in which the joining device projects from the transverse member in the lateral direction.

2. The module according to claim 1, wherein when the joining device is in the standby position it is connected to its associated end of the transverse member by an articulated connection, allowing the joining device to move towards its deployed joining position, in which the joining device is situated in a continuation of the transverse member in order therewith to form an assembly that is continuous in the lateral direction.

3. The module according to claim 1, wherein when the joining device is in the deployed joining position it is fixed to its associated end of the transverse member by a plurality of tightening members or bolts, oriented substantially orthogonally to the lateral direction of the module.

4. The module according to claim 3, wherein the tightening members pass through oblong passage holes made through the end of the transverse member.

5. The module according to claim 1, wherein the joining device has a friction surface collaborating with a complementary friction surface on the web of the transverse member, when the joining device is in its deployed joining position.

6. The module according to claim 1, wherein the joining device comprises a joining end for joining to the fuselage frame, the joining end comprising a contact surface through which passage holes pass to accept a plurality of traction members that are configured to collaborate with the fuselage frame when the joining device is in its deployed joining position.

7. The module according to claim 6, wherein in a plane of section parallel to the lateral direction and to a vertical direction of the module and which passes through the transverse member, the contact surface is shaped as a straight line segment inclined with respect to the vertical direction.

8. The module according to claim 1, comprising at least one or more of components as follows:
a floor comprising the at least one transverse member;
at least one system;
at least one cockpit lining;
at least one door system;
at least one bulk head;
at least one onboard galley;
at least one toilet cubicle.

9. The module according to claim 1, wherein the transverse member equipped with the joining device is arranged in a rear part of the module.

10. The module according to claim 1, wherein the transverse member comprises a joining device at each of its opposite ends, and/or wherein several transverse members of the module are each equipped with at least one joining device.

11. An aircraft part comprising a fuselage forming a structural envelope and comprising fuselage frames, the aircraft part also comprising at least one module according to claim 1 assembled in an interior space defined by the fuselage, with each joining device being in the deployed joining position and fixed to at least one of the fuselage frames.

12. The aircraft part according to claim 11, wherein it is an aircraft nose cone.

13. An aircraft comprising at least one part according to claim 11.

14. A method for assembling an aircraft part, the aircraft part comprising a fuselage forming a structural envelope and comprising fuselage frames, the aircraft part also comprising at least one module according to claim 1 assembled in an interior space defined by the fuselage, with each joining device being in the deployed joining position and fixed to at least one of the fuselage frames, the method comprising:
placing the module facing and a distance away from its definitive location in the interior space defined by the fuselage, with each joining device in the standby position;
moving the module to bring it into its definitive location;
moving each joining device into its deployed joining position; and
fixing each joining device to the fuselage frame(s).

15. The method according to claim 14, wherein moving the module comprises setting the module in a translational movement in a longitudinal direction of the module and of the fuselage until the module reaches its definitive location.
